(19) United States
(12) Patent Application Publication
(10) Pub. No.: US 2002/0144450 A1
(43) Pub. Date: Oct. 10, 2002

(54) Fishing lure retrieving device

(76) Inventor: Ricky E. Caraway, Granbury, TX (US)

Correspondence Address: DECKER, JONES, MCMACKIN, MCCLANE, HALL &, BATES, P.C., BURNETT PLAZA 2000, 801 CHERRY STREET, UNIT #46, FORT WORTH, TX, 76102-6836, US

(21) Appl. No.: 09/829,020

(22) Filed: Apr. 9, 2001

(51) Int. Cl. A01K 97/00

(52) U.S. Cl. 43/17.2

(57) ABSTRACT

The fishing lure retrieving device has a weight which has a slit extending lengthwise to about the central axis of the weight. A fishing line may be located in the slit so the line extends centrally through the weight. coils are attached centrally at each end of the weight for receiving and maintaining the line about the central axis of the weight. Chains are coupled to a sleeve of the weight which extends about an end of the weight. The weight is allowed to slide down the fishing line to forcibly impact the lure to jar the lure loose from an obstruction. The chains may ensnare the hook of the lure to allow the lure to be freed. A retrieving cord is attached to the weight so the weight and lure may be retrieved.

### BACKGROUND OF THE INVENTION

1. Field of the Invention

The present invention relates to a fishing lure retrieving device for retrieving a fishing lure that becomes snagged on or attached to obstructions in a fishing area.

2. Description of the Prior Art

Often, while fishing, the fishing lure in use becomes entangled in obstructions in the water. In some cases the fishing lure may be jostled free from the obstruction merely by jiggling the line. At other times, however, the snagged fishing lure cannot be freed resulting in loss of the fishing lure which can be an expensive item.

Therefore, a device for retrieving a snagged fishing lure is needed. Several fishing lure retrieving devices are know in the art, including: Bray, U.S. Pat. No. 2,397,916; Bivens, U.S. Pat. No. 2,594,852; Russell, U.S. Pat. No. 2,770,062; Taylor, U.S. Pat. No. 2,809,460; Terry, U.S. Pat. No. 3,010,241; Cottrell, U.S. Pat. No. 3,012,355; Stevens, U.S. Pat. No. 3,144,728; Sobetzer, U.S. Pat. No. 3,191,335; Skarnells, U.S. Pat. No. 4,408,411; and O'Brien, et al., U.S. Pat. No. 4,598,493.

### SUMMARY OF THE INVENTION

It is an object of the invention to provide a new and useful lure retrieving apparatus.

The apparatus comprises a weight having a slit for receiving a fishing line extending lengthwise along the weight from the first end to a second end thereof. The slit extends to about the center of the weight. A fishing line may be located in the slit so as to extend throughout he weight. First and second holding means are coupled to the first and second ends, respectively, of the weight for holding a fishing line in the slit. At least one chain is coupled to the weight. The weight may be slidably moved along the fishing line to impact the fishing lure and obstruction in order to jar the lure loose from the obstruction. The chain is adapted to snare a fishing hook so the lure may be engaged and retrieved by the apparatus.

### BRIEF DESCRIPTION OF THE DRAWINGS

FIG. 1 is an isometric view of a preferred embodiment of the fishing lure retriever of the present invention.

FIG. 2 is an isometric bottom view of the fishing lure retriever with the chains removed for clarity.

FIG. 3 is a partial cross-sectional side view of the fishing lure retriever with the chains removed for clarity showing a fishing line extending therethrough.

FIG. 4 is a side view of the fishing lure retriever with a fishing line extending therethrough adjacent a fishing lure snared on an obstruction.

### DESCRIPTION OF THE PREFERRED EMBODIMENTS

Referring now to the drawings, there is disclosed a lure retrieving device 11 for retrieving a snagged fishing lure 13. The retrieving device 11 is comprised of a weight 15 through which a fishing line 17 may pass, and coil springs 19 and chains 21 attached to the weight 15. When the fishing hooks 23 of the lure 13 becomes snagged on an obstruction 22 the weight 15 may be attached to the fishing line 17 and secured thereon by the coil springs 19. The weight 15 is allowed to slide down the line 17 to the snagged lure 13. Impact of the weight 15 against the lure 13 and the obstruction 22 may jar the lure 13 loose from the snagging obstruction. However, if the lure 13 remains snagged, the device 11 may be jogged on the line 17 to catch a fishing hook 23 in one or more of the chains 21. The device 11 and the lure 13 may then be retrieved by reeling in a retrieving cord 25 that is secured to the weight 15 through a weight retrieving eyelet 27.

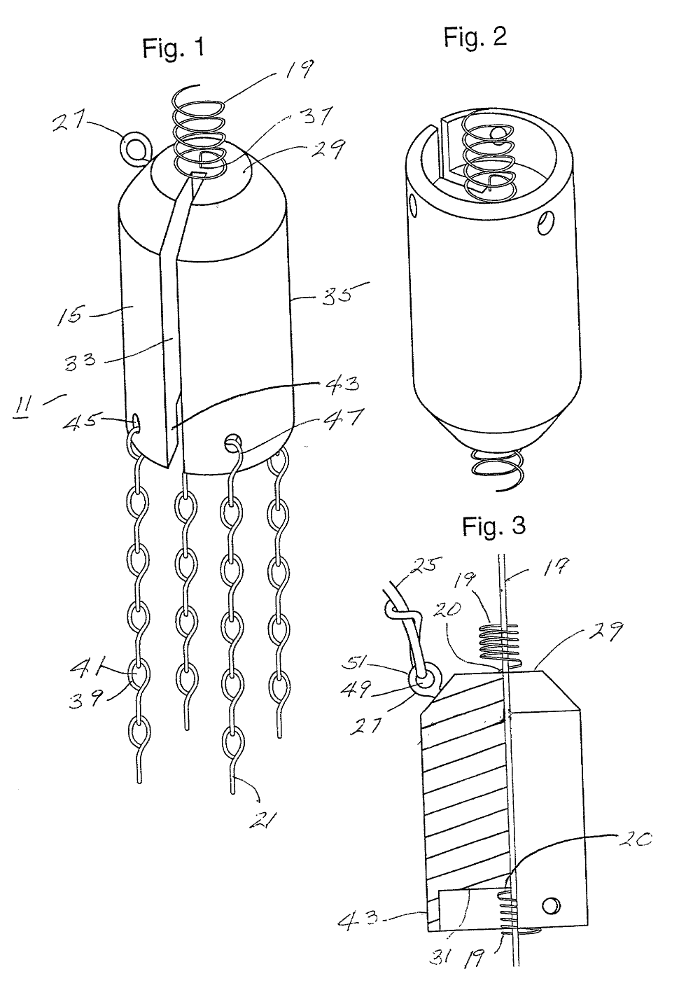

As shown in FIGS. 1-3, the weight 15 is generally cylindrical member extending lengthwise between ends 29 and 31. The weight 15 is formed of a metal material such as cast zinc, cast iron, or lead which renders the weight relatively heavy so the weight 15 may provide jarring force to the lure 13 and the obstruction 22 upon impact. In one embodiment, the weight 15 weighs approximately thirty ounces, is about six inches long and is 2 inches in diameter.

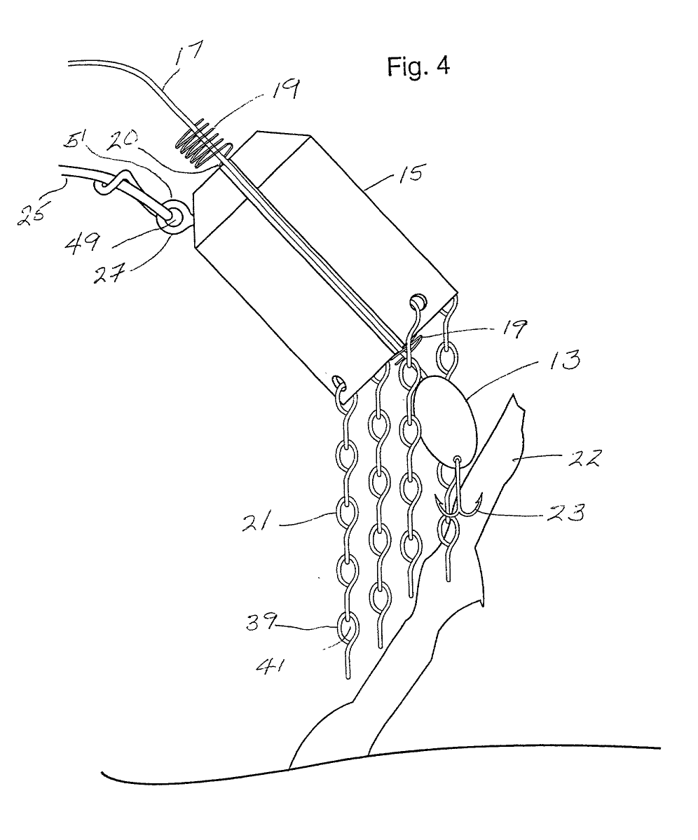

As shown in FIG. 3, the weight 15 is constructed to permit a fishing line 17 to extend centrally through the weight 15 so the weight 15 may be moved easily along the fishing line 17 to the snagged lure 13. Referring to FIGS. 1 and 2, a slit 33 extends lengthwise through the weight 15 between the ends 29 and 31. The slit 33 extends radially through the cylindrical weight 15 from the outer surface 35 of the weight 15 to a location near the center 37 of the weight 15. As shown in FIG. 4, the slit 33 is sufficiently wide to receive the fishing line 17 lengthwise through the slit 33 so the fishing line 17 may extend centrally through the weight 15 from end 29 to end 31.

Referring now to FIGS. 3 and 4, a coil spring 19 is secured to each end 29 and 31 of the weight 15 to secure the weight 15 on the fishing line 17 when the line 17 is located in the slit 33 of the weight 15. The coil springs 19 may be commercially available metal springs. The ends 20 of the coil springs 19 are secured to the ends 29 and 31 of the weight 15 by suitable means such as welding, or the ends may have threads which are screwed into threaded apertures. The coil springs 19 are centrally attached to the ends 29 and 31 of the weight 15 so the fishing line 17 may extend through the centers of the coils of the coil springs 19 when the line 17 is located extending centrally through the slit 33 of the weight 15. The coils of the coil springs 19 permit ingress and egress of the fishing line 17 between the individual coils so the line 17 may be directed spirally through the coils by hand to locate the line 17 within the centers of the coils springs 19, or to remove the line 17 from the coil springs 19. The coil springs maintain the line at about the center of the weight 15.

As shown in FIGS. 1 and 4, the chains 21 are attached to the weight 15 extending outward from the end 31 of the weight 15 so the chains 21 may be located in a position to snag the fishing hook 23 of the lure 13. The fishing hook 23 may be a treble hook so the chains 21 may more easily snag the hook 23. The chains 21 are conventional chains formed of multiple metal chain links 39 each of which has an aperture 41 extending therethrough. The chains 21 are relatively long and flexible having numerous apertures 41 approximately sized to engage the fishing hook 23. In a preferred embodiment, four, seven inch long chains 21 are attached to the cylindrical weight 15 at ninety degree intervals. More or less chains 21 may be used, having a greater or smaller length, as desired.

As shown in FIGS. 1 and 2, the chains 21 are coupled to the weight 15 from a sleeve 43 that extends from the end 31 of the weight 15. The sleeve 43 extends from end 31 of the weight 15 coinciding with the circumference of the weight 15 at end 31. Coil spring 19 at end 31 of the weight 15 extends outwards further from the end 31 than the sleeve 43. The slit 33 extends through the sleeve 43. Apertures 45 extend through the sleeve 43 for use for securing the chains 21 to the weight 15. In a preferred embodiment, four apertures 45 extend through the sleeve 43 at ninety degree intervals. As shown in FIG. 1, an end link 47 of each chain 21 is looped through a chain receiving aperture 45 to secure the chain 21 to the weight 15.

Referring to FIGS. 3 and 4, the retrieving cord 25 is attached to the retrieving eyelet 27 adjacent the end 29 of the weight 15 so the weight 15 may be retrieved by reeling in the retrieving cord 25. The retrieving cord 25 has sufficient length to be extended with the weight 15 along the fishing line 17 to the obstruction site 22. The retrieving cord 25 is considerably stronger than the fishing line 17 so the retrieving cord 25 is much less likely to be broken upon an attempt to pull the weight 15 and the lure 13 free from the obstruction. The retrieving cord 25 is secured to the weight 15 by being tightly knotted in an eye hole 49 of the retrieving eyelet 27.

The retrieving eyelet 27 is an eye loop 51 enclosing an eye hole 49 located near the end 29 of the weight 15 opposite the end 31 from which the chains 21 extend. In a preferred embodiment, the retrieving eyelet 27 is an eye bolt having its shank screwed or welded to the weight 15. In another embodiment (not shown), the retrieving eyelet may be formed by an aperture extending through the weight.

Referring now to FIG. 4, in operation the lure retrieving device 11 is used when the hook 23 of a lure becomes snagged in a branch 22 or weeds or other snagging obstructions 22 in the water being fished. It is desirable to recover the fishing lure since fishing lures are often expensive, and replacement of a lost lure is an inconvenience to the fisherman.

The lure retrieving device 11 is initially located on the fishing line 17 approximate to the fishing rod (not shown). The line 17 is positioned extending lengthwise through the slit 33 in the weight 15, and the weight 15 is centered on the fishing line 17 with the line 17 extending centrally through the weight 15. The weight 15 is secured to the line 17 by winding the line 17 spirally through the coil springs 19 at each end 29 and 31 of the weight 15. The retrieving cord 25 is attached to the weight 15 by extending cord 25 through the eyehole 49 of the retrieving eyelet 27 and knotting the cord 25 therein.

The retrieving device 11 is allowed to slide down the line 17 to the vicinity of the snagged lure 13, paying out the retrieving cord 25 to allow the device 11 to move along the line 17 to impact the snagged lure 13 to jar its hook loose from the obstruction 22. If the lure 13 is not freed upon the initial impact, repeated impacts may be performed by pulling the retrieving cord 25 in to pull the device 11 up the fishing line 17, then letting the device 11 slide along the line 17 to impact the lure 13 and obstruction 22 again. When the lure 13 is freed the device 11 and the lure are retrieved by reeling in the retrieving cord 25.

If the lure 13 cannot be freed by impacting the device 11 against the lure 13 and the obstruction, the device 11 may be jogged on the fishing line 17 in an up and down motion to ensnare the hook 23 in one of the chains 21. After a chain 21 has firmly engaged the hook 23, the device 11 and lure 13 are retrieved by reeling in the retrieving cord 25.

The foregoing disclosure and the showings made in the drawings are merely illustrative of the principles of this invention and are not to be interpreted in a limiting sense. For example, the weight 15 is not limited to a cylindrical shape and may have a polygonal shape.

1. A fishing lure retrieving apparatus, comprising:
a weight having a first end, a second end, and an outer surface;
a slit extending lengthwise along said weight from said first end to said second end of said weight, said slit extending into said weight from said outer surface to an inner position for receiving a fishing line to extend through said weight;
a first holding means coupled to said first end of said weight for maintaining a fishing line in said slit at said first end;
a second holding means coupled to said second end of said weight for maintaining a fishing line in said slit at said second end;
at least one chain coupled to said weight.

2. The fishing lure retrieving apparatus of claim 1 wherein:
said first and second holding means each comprises a coiled spring.

3. The fishing lure retrieving apparatus of claim 2, wherein:
said weight has a sleeve extending from said second end of said weight;
said sleeve has a plurality of chain receiving apertures extending therethrough;
a plurality of chains are coupled to said weight through said chain receiving apertures in said sleeve;
said slit extends through said sleeve.

4. The fishing lure retrieving apparatus of claim 2, further comprising an coupling means coupled to said outer surface of said weight near said first end of said weight, said coupling means being adapted to have a cord coupled thereto for use for retrieving said weight.
